(19) United States
(12) Patent Application Publication
(10) Pub. No.: US 2019/0162316 A1
(43) Pub. Date: May 30, 2019

(54) BALL WITH HIGH WEAR RESISTANCE AND BALL VALVE USING THE SAME

(71) Applicant: DAEHANCVD CO., LTD., Chungcheongbuk-do (KR)

(72) Inventors: Do-Hun KIM, Daejeon (KR); Dae-Yong HAN, Jeollabuk-do (KR); Jin-Young PARK, Daejeon (KR)

(73) Assignee: DAEHANCVD CO., LTD.

(21) Appl. No.: 15/875,085

(22) Filed: Jan. 19, 2018

(30) Foreign Application Priority Data
Nov. 28, 2017 (KR) 10-2017-0159813

(51) Int. Cl. F16K 5/06; F16K 25/00; F16K 25/04

(52) U.S. Cl. CPC F16K 5/0657; F16K 27/067; F16K 25/04; F16K 25/005

(57) ABSTRACT

A ball installed in a ball valve is provided. The ball includes: a ball main body including a penetrating hole penetrating from a front portion to a rear portion thereof and having a predetermined diameter, and a concave recess formed on an upper portion thereof to be coupled to a stem of the ball valve; and insert members coupled to a left side and a right side of the ball main body, wherein the insert members are coupled to the ball main body, such that, when the ball is installed in the ball valve and is placed in a position for closing the ball valve, each of the insert members covers a region of the ball contacting a seat of the ball valve, wherein the insert members are formed of a super hardness material.

### CROSS-REFERENCE TO RELATED PATENT APPLICATION

This application claims priority from Korean Patent Application No. 10-2017-0159813, filed on Nov. 28, 2017 in the Korean Intellectual Property Office, the disclosure of which is incorporated herein by reference in its entirety.

### FIELD

The present disclosure relates to a ball valve for flow control, and more particularly, to a ball with high wear resistance and a ball valve using the same.

### BACKGROUND

Ball valves are widely used as one of the valves for flow control. For example, the ball valve has a normal configuration as shown in FIG. 1, in which a ball 20 is rotatably disposed in a main body 11 of the ball valve 10, and a penetrating hole 21 is formed on the ball 20. A stem 30 is coupled to an upper portion of the ball 20. When the ball 20 is rotated by operating the stem 30 automatically or manually to align the penetrating hole 21 of the ball 20 with pipes 12, 13, the valve is opened. When the ball 20 is rotated by 90 degrees, the surface of the ball 20 comes into close contact with a ring-shaped seat 14 installed in the valve main body 11 and the pipes 12, 13 are blocked and thus the valve is closed.

In general, to make the ball 20 to be used for the ball valve, the ball is fabricated by a metallic material such as stainless steel, and the surface of the ball is coated by thermal spray coating to have high hardness. However, when the ball valve is installed and used in an industrial facility such as a semiconductor wafer fabrication factory, an oil refining factory, and a steel mill, a fluid containing slurry particles of high hardness such as silica, silicon, etc. flows through the pipes and wears down the ball. When the ball is worn down by the high hardness slurry, a gap is generated between the surface of the ball 20 and the seat 14 of the ball valve and thus a leakage occurs. Therefore, the original function of the valve is degraded and thus the ball valve should be frequently replaced and a cost increases.

To prevent this problem, the ball 200 may be made of a super hardness alloy to increase the lifespan of the ball. However, a fabrication cost may increase, and also, since the specific gravity of the super hardness alloy is great, there is a disadvantage that it is difficult to make a ball of a predetermined size or more. In addition, since the ball made of the super hardness alloy has strong brittleness, there is a disadvantage that the ball is fragile.

Therefore, there is a demand for enhancing wear resistance of a ball valve which is used for controlling a flow of a fluid containing slurry, and increasing the lifespan of the ball valve.

### SUMMARY

One or more exemplary embodiments may overcome the above disadvantages and other disadvantages not described above. However, it is understood that one or more exemplary embodiment are not required to overcome the disadvantages described above, and may not overcome any of the problems described above.

One or more exemplary embodiments provide a ball for a ball valve, which has an insert member of a super hardness material coupled to a region of a surface of the ball that comes into close contact with a seat of the ball valve to perform a sealing role, and is directly worn down by a flow of a fluid.

According to an aspect of an exemplary embodiment, there is provided a ball installed in a ball valve, the ball including: a ball main body including a penetrating hole penetrating from a front portion to a rear portion thereof and having a predetermined diameter, and a concave recess formed on an upper portion thereof to be coupled to a stem of the ball valve; and insert members coupled to a left side and a right side of the ball main body, wherein the insert members are coupled to the ball main body, such that, when the ball is installed in the ball valve and is placed in a position for closing the ball valve, each of the insert members covers a region of the ball contacting a seat of the ball valve, wherein the insert members are formed of a super hardness material.

According to an exemplary embodiment, the insert members may include one of the following materials: (i) sintered tungsten carbide having a Rockwell hardness (HRa) ranging from 81 to 93; (ii) a member having a Vickers hardness ranging from 1700 to 3000, which is obtained by applying CVD or PVD coating to the sintered tungsten carbide; (iii) a member having a Vickers hardness (Hv) ranging from 1700 to 3500, which is obtained by applying CVD or PVD coating to stainless steel; (iv) alumina ceramic having an HRa of 86 or higher; and (v) zirconia ceramic having an HRa of 86 or higher.

According to an exemplary embodiment, a left side surface and a right side surface of the ball main body each may include a flat surface, and may include a protrusion protruding outward from each of the flat surfaces of the left side surface and the right side surface. The insert member may include a recess to be engaged with the protrusion, and the protrusion may be inserted into the recess, such that the insert member is coupled to each of the left side surface and the right side surface of the ball main body.

According to an exemplary embodiment, a left side surface and a right side surface of the ball main body each may include a flat surface, and may include a protrusion protruding outward from each of the flat surfaces of the left side surface and the right side surface. The insert member may be a ring-shaped member surrounding the protrusion, and the ring-shaped insert member may fit over the protrusion, such that the insert member is coupled to each of the left side surface and the right side surface of the ball main body.

According to an aspect of another exemplary embodiment, there is provided a ball valve including the above-described ball.

According to an exemplary embodiment, an insert member of a super hardness material is used on a region of a surface of a ball that comes into close contact with a seat of a ball valve to perform a sealing role, and is directly worn down by a flow of a fluid, such that the wear resistance of the ball can be enhanced and the lifespan of the ball can be increased. Therefore, there is an advantage that the effect of reducing an installation and maintenance cost of the ball valve can be achieved.

Additional and/or other aspects and advantages of the invention will be set forth in part in the description which follows and, in part, will be obvious from the description, or may be learned by practice of the invention.

### BRIEF DESCRIPTION OF THE DRAWINGS

The above and other features and advantages will become more apparent by describing in detail exemplary embodiments with reference to the attached drawings in which:

FIG. 1 is a view to illustrate a configuration of a related-art ball valve;

FIG. 2A is a view to illustrate a ball according to a first exemplary embodiment;

FIG. 2B is a view to illustrate a ball according to a first exemplary embodiment;

FIG. 3 is a view to illustrate a ball according to a first exemplary embodiment;

FIG. 4A is a view to illustrate a ball according to a second exemplary embodiment;

FIG. 4B is a view to illustrate a ball according to a second exemplary embodiment;

FIG. 5 is a view to illustrate a ball according to a second exemplary embodiment;

FIG. 6A is a view to illustrate a ball according to a third exemplary embodiment;

FIG. 6B is a view to illustrate a ball according to a third exemplary embodiment;

FIG. 7 is a view to illustrate a ball according to a third exemplary embodiment;

FIG. 8A is a view to illustrate a ball according to a fourth exemplary embodiment;

FIG. 8B is a view to illustrate a ball according to a fourth exemplary embodiment;

FIG. 9 is a view to illustrate a ball according to a fourth exemplary embodiment;

FIG. 10A is a view to illustrate an effect achieved by the shape of the ball according to the second exemplary embodiment; and

FIG. 10B is a view to illustrate an effect achieved by the shape of the ball according to the second exemplary embodiment.

### DETAILED DESCRIPTION

Exemplary embodiments will now be described more fully with reference to the accompanying drawings to clarify aspects, other aspects, features and advantages of the inventive concept. The exemplary embodiments may, however, be embodied in many different forms and should not be construed as limited to the exemplary embodiments set forth herein. Rather, the exemplary embodiments are provided so that this disclosure will be thorough and complete, and will fully convey the scope of the application to those of ordinary skill in the art.

It will be understood that when an element is referred to as being “on” another element, the element can be directly on another element or intervening elements. In the drawings, thickness of elements are exaggerated for effective explanation of the technical features.

If the terms such as ‘first’ and ‘second’ are used to describe elements, these elements should not be limited by such terms. These terms are used for the purpose of distinguishing one element from another element only. The exemplary embodiments include their complementary embodiments.

As used herein, the singular forms “a”, “an” and “the” are intended to include the plural forms as well, unless the context clearly indicates otherwise. It will be further understood that the terms “comprises” and/or “comprising,” when used in this specification, do not preclude the presence or addition of one or more other components.

Hereinafter, exemplary embodiments will be described in greater detail with reference to the accompanying drawings. The matters defined in the description, such as detailed construction and elements, are provided to assist in a comprehensive understanding of the exemplary embodiments. However, it is apparent that the exemplary embodiments can be carried out by those of ordinary skill in the art without those specifically defined matters. In the description of the exemplary embodiment, certain detailed explanations of related art are omitted when it is deemed that they may unnecessarily obscure the essence of the inventive concept.

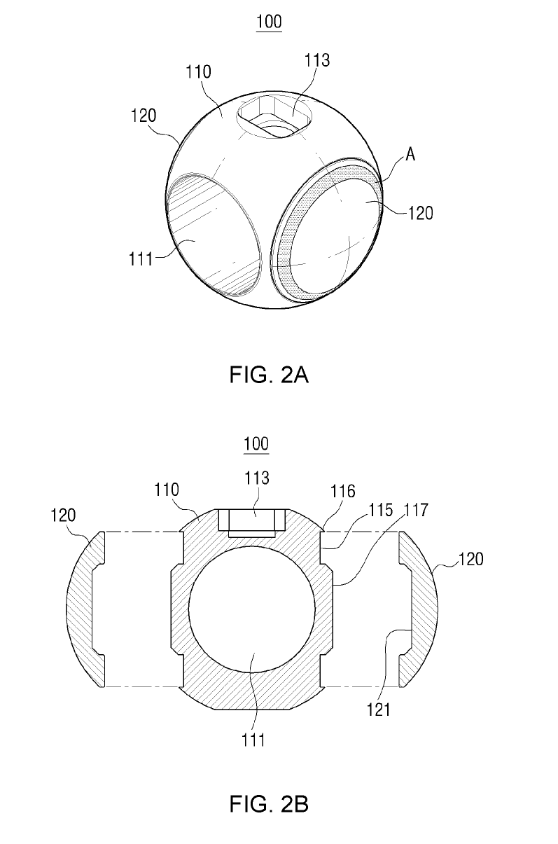

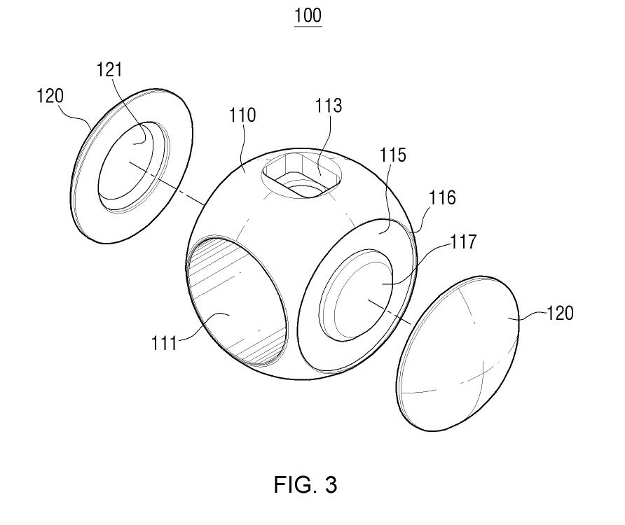

FIGS. 2A and 2B and 3 are views to illustrate a ball 100 according to a first exemplary embodiment. FIG. 2A is a perspective view of the ball 100, FIG. 2B is an exploded cross-sectional view seen from the front, and FIG. 3 is an exploded perspective view.

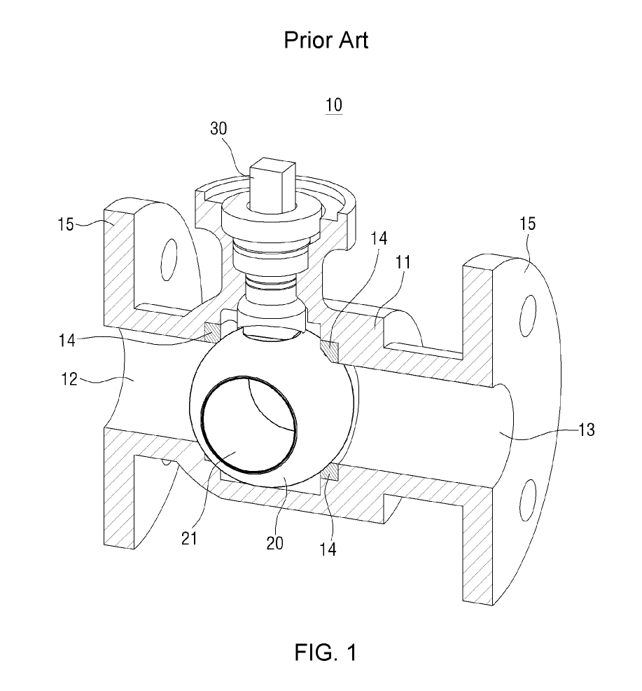

Referring to the drawings, the ball 100 according to the first exemplary embodiment includes a ball main body 110 and insert members 120 attached to both side surfaces of the ball main body 110. The ball main body 110 includes a penetrating hole 111 penetrating from the front portion to the rear portion thereof and having a predetermined diameter, and a concave recess 113 formed on an upper portion thereof. The penetrating hole 111 is formed to allow a fluid to flow therethrough when a ball valve is opened. The concave recess 113 is to receive an end of a stem (for example, 30 of FIG. 1) of the ball valve, and the end of the stem 30 is inserted and coupled to the concave recess 113, such that the ball 100 and the stem 30 can be integrally rotated.

In the following description, a direction in which the penetrating hole of the ball passes will be referred to as a “front surface” and a “rear surface” of the ball for convenience of explanation. That is, in FIGS. 2A and 2B, the penetrating hole 111 penetrates through the ball from the “front surface” to the “rear surface” of the ball. In addition, it will be understood that the concave recess 113 for coupling to the stem of the ball valve is formed on an “upper surface” of the ball main body 110, and the insert members 120 are attached to a “left side surface” and a “right side surface” of the ball main body 110, respectively.

In the illustrated embodiment, each of the left side surface and the right side surface of the ball main body 110 includes a flat surface 115, and includes a protrusion 117 protruding from the surface 115 outwardly, that is, in a direction of being further away from the center of the ball main body 110. The protrusion 117 may be integrally formed with the ball main body 110. In an exemplary embodiment, the ball main body 110 may further include a rim 116 protruding along an outer edge of the flat surface 115 to a predetermined height.

The outer surface of the insert member 120 is a portion forming the surface of the ball 100 and may be formed of a curved surface. For example, the outer surface of the insert member 120 may have the same or similar radius of curvature as or to the radius of curvature of the ball main body 110. A concave recess 121 may be formed on an inner surface of the insert member 120. Preferably, the recess 121 of the insert member 120 may have a shape to be engaged with the protrusion 117 of the ball main body 110, and accordingly, the protrusion 117 is inserted into the recess 121 such that the insert member 120 is coupled to the ball main body 110.

In an exemplary embodiment, the insert member 120 may be coupled to the ball main body 100 by using at least one of laser welding, an adhesive, and screwing. In the case of laser welding, the ball main body 110 and the insert member 120 may be coupled to each other by laser welding along a boundary line therebetween. In the case of an adhesive, the insert member 120 may be coupled to the ball main body 110 by coating the flat surface 115 of the ball main body 110 and the surface of the protrusion 117 with an adhesive. In the case of screwing, the insert member 120 may be coupled to the ball main body 110 by inserting one or more screw into the inside of the protrusion 117 through the insert member 120. In addition, two or more of the above-mentioned three coupling methods may be combined. For example, the adhesive and the laser welding method may be used simultaneously or the screwing and the laser welding method may be used simultaneously.

The insert members 120 attached to the ball main body 110 may form the left side surface and the right side surface of the ball 100. In this case, a surface of the insert member 120 may be configured to cover a region of the ball contacting a seat (that is, 14 of FIG. 1) of a ball valve. That is, a surface shape of the insert member 120 may be defined in such a manner that, when the ball 100 is installed in the ball valve and is placed in a position for closing the ball valve as shown in FIG. 1, a region (“A” region of FIG. 2) contacting the seat 14 is positioned on the surface of the insert member 120.

In an exemplary embodiment, the ball main body 110 may be fabricated by a metal alloy. For example, the ball main body 110 may be fabricated by one or more kinds of alloys selected from the group consisting of nickel alloy, cobalt alloy, stainless steel, and carbon steel. In another exemplary embodiment, after the ball main body 110 is fabricated by the metal alloy, a high hardness coating treatment may be performed on the surface. For example, a coating treatment such as chrome carbide high velocity oxygen-fuel spraying (HVOF), tungsten carbide HVOF, nickel-chrome fusing, cobalt alloy spray coating, etc. may be performed.

In an exemplary embodiment, the insert member 120 may be formed of a super hardness material having wear resistance. In an exemplary embodiment, the insert member 120 may be fabricated by a super hardness alloy. The super hardness alloy is an alloy made by sintering metal carbide powder and having very high hardness, and may have Rockwell hardness (HRa) ranging from 83 to 93.5. In an exemplary embodiment, the super hardness alloy may include a tungsten-cobalt-based alloy (for example, WC—Co, WC—TiC—TaC—Co, etc.) having a good mechanical property from a room temperature to a high temperature.

In addition, in an exemplary embodiment, the insert member 120 may be formed of at least one of the following materials:

(i) sintered tungsten carbide having Rockwell hardness (HRa) ranging from 81 to 93, wherein the tungsten carbide contains cobalt or nickel by 3% to 24% as a binder;

(ii) a member having Vickers hardness (Hv) ranging from 1700 to 3000, which is obtained by applying chemical vapor deposition (CVD) or physical vapor deposition (PVD) coating to the sintered tungsten carbide, wherein the member has Vickers hardness (Hv) ranging from 1700 to 2400 by applying a CVD coating treatment to the tungsten carbide, or has Hv hardness ranging from 1800 to 3000 by applying a PVD coating treatment to the tungsten carbide using titanium aluminum nitride (TiAlN);

(iii) a member having Vickers hardness ranging from 1700 to 3500, which is obtained by applying CVD or PVD coating to stainless steel, wherein the member has Vickers hardness ranging from 1700 to 2300 by applying CVD to SS431 stainless steel, or has Vickers hardness ranging from 2000 to 3500 by applying PVD to SS431 stainless steel using TiAlN;

(iv) alumina (Al₂O₃) ceramic having HRa of 86 or higher; and

(v) zirconia (ZrO₂) ceramic having HRa of 86 or higher.

According to the exemplary embodiment as described above, by attaching the insert member 120 of the super hardness material to the region of the surface of the ball 100 that performs the role of sealing in close contact with the seat 14 and is directly worn down by a flow of a fluid, the wear resistance of the ball can be enhanced and the lifespan of the ball can be increased, and an effect of reducing an installation and maintenance cost of the ball valve can be achieved.

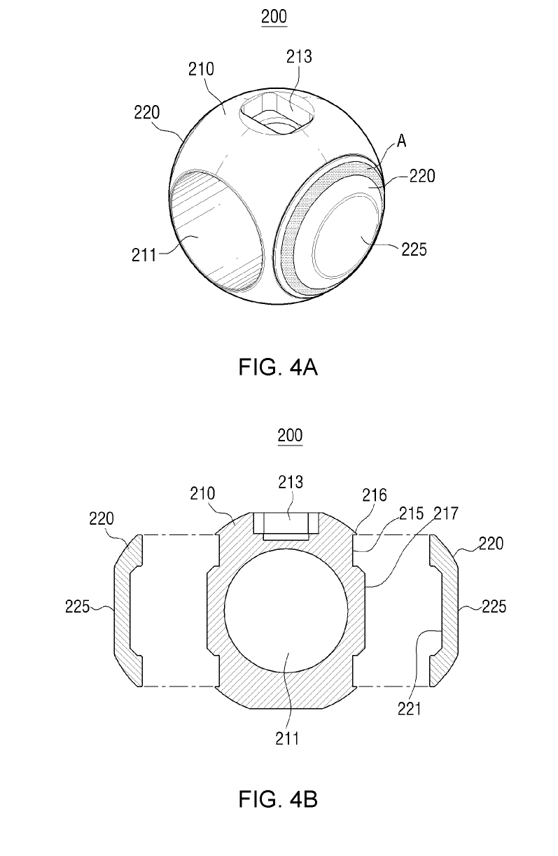

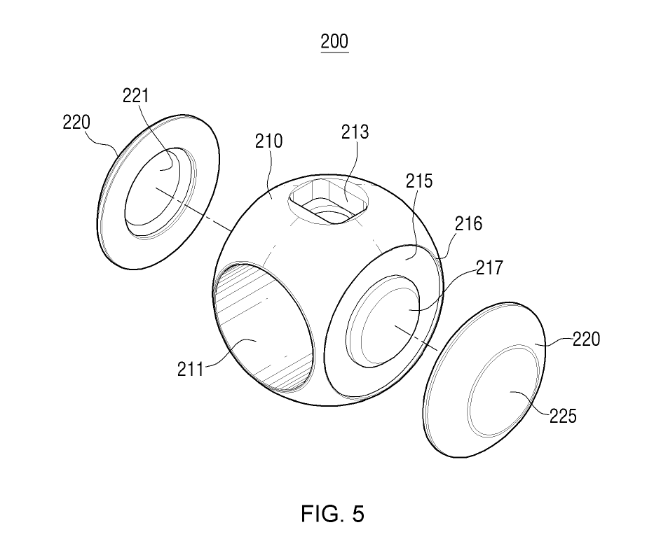

FIGS. 4A and 4B and 5 are views to illustrate a ball 200 according to a second exemplary embodiment. FIG. 4A is a perspective view of the ball 200, FIG. 4B is a cross-sectional view seen from the front, and FIG. 5 is an exploded perspective view.

Referring to the drawings, the ball 200 according to the second exemplary embodiment includes a ball main body 210 and insert members 220 attached to both side surfaces of the ball main body 210. The ball main body 210 includes a penetrating hole 211 penetrating from the front portion to the rear portion thereof and having a predetermined diameter, and a concave recess 213 formed on an upper portion thereof to be coupled to a stem (for example, 30 of FIG. 1) of a ball valve.

Each of the left side surface and the right side surface of the ball main body 210 includes a flat surface 215, and includes a protrusion 217 protruding from the surface 215 outwardly, that is, in a direction of being further away from the center of the ball main body 210. The protrusion 217 may be integrally formed with the ball main body 210. In an exemplary embodiment, the ball main body 210 may further include a rim 216 protruding along an outer edge of the flat surface 215 to a predetermined height.

In the second exemplary embodiment, the two insert members 220 are attached to the left and right sides of the ball main body 210, respectively, thereby forming the ball 200. In this case, preferably, a surface of the insert member 220 may be configured to cover a region contacting a seat (for example, 14 of FIG. 1) of a ball valve. That is, it is preferable that, when the ball 200 is installed in the ball valve and is placed in a position for closing the ball valve as shown in FIG. 1, a surface of the insert member 220 has a region (“A” region in FIG. 4A) contacting the seat 14 of the ball valve.

In the second exemplary embodiment, the insert member 220 may have a cut flat surface 225 formed on a portion of the outer surface thereof. The cut surface 225 may be configured to face the side surface of the ball main body 210. That is, the cut surface 225 of the insert member 220 attached to the left side surface of the ball main body 210 may face outward from the left side of the ball 200, and the cut surface 225 of the insert member 220 attached to the right side surface of the ball main body 210 may face outward from the right side of the ball 200.

An outer surface of the insert member 220 except for the cut surface 225 may be formed of a curved surface. For example, the outer surface of the insert member 220 may have the same or similar radius of curvature as or to the radius of curvature of the ball main body 210. In this case, it will be understood that the region (“A” region) where the ball 200 contacts the seat 14 of the ball valve is positioned on the curved surface of the insert member 220.

The insert member 220 may have a concave recess 221 formed on an inner surface thereof, and the concave recess 221 is configured to be engaged with the protrusion 217 of the ball main body 210. Accordingly, the protrusion 217 is inserted into the recess 221, such that the insert member 220 is coupled to the side surface of the ball main body 210.

As mentioned in the first exemplary embodiment, the insert member 220 may be coupled to the ball main body 219 by using at least one of laser welding, an adhesive, and screwing.

In addition, as mentioned in the first exemplary embodiment, the ball main body 210 may be fabricated by a metal alloy and then a high hardness coating treatment may be applied to the ball main body 210. The insert member 220 may be formed of a super hardness material having wear resistance. Specific materials of the ball main body 210 and the insert member 220 may be the same as or similar to those of the first exemplary embodiment, and thus a detailed description is omitted.

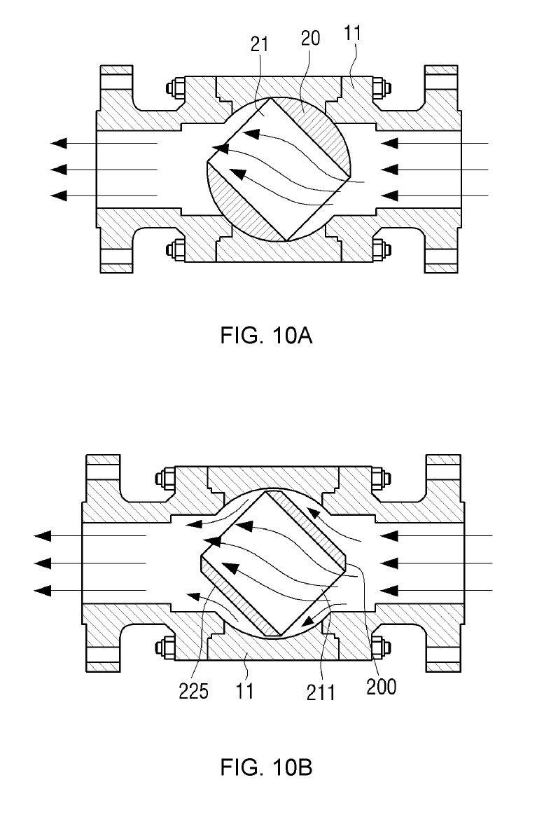

Meanwhile, when the insert member 220 has the cut surface 225 as in the second exemplary embodiment, there is an effect that slurry in a fluid is prevented from being deposited in a main body (that is, 11 of FIG. 1) of a ball valve. Regarding this, FIGS. 10A and 10B schematically illustrate a ball valve provided with a normal spherical ball 20, and a ball valve provided with the ball 200 having the cut surface 225 according to the second exemplary embodiment, respectively.

In the case of the normal spherical ball 20 of FIG. 10A, when the ball valve is opened and closed by rotation of the ball 20, slurry in a fluid may clog a gap between the valve main body 11 and the ball 20 and may be deposited. However, in the case of the ball valve provided with the ball 200 according to the second exemplary embodiment as shown in FIG. 10B, an outer diameter of the cut surface 225 of the ball 200 is smaller than an outer diameter of the uncut portion, a fluid may flow through a space between the cut surface 225 and the ball valve main body 11. Accordingly, since the fluid performs a flushing function while flowing through this space rapidly every time the ball valve is opened and closed, the phenomenon that the slurry is deposited can be reduced.

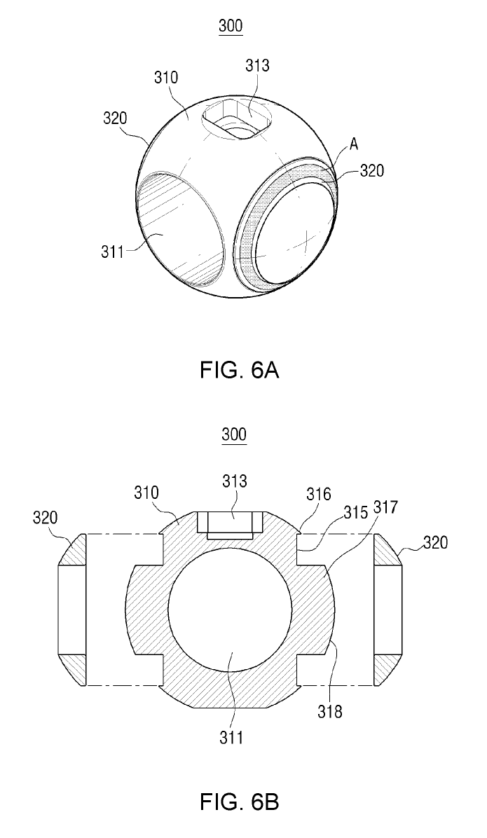

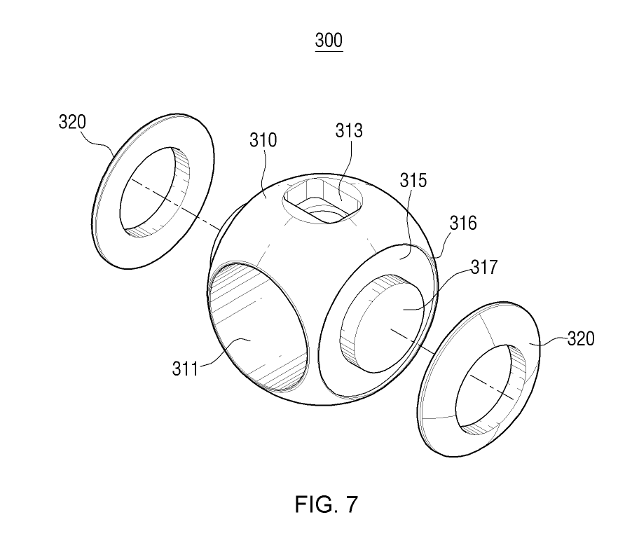

FIGS. 6A and 6B and 7 are views to illustrate a ball 300 according to a third exemplary embodiment. FIG. 6A is a perspective view of the ball 300, FIG. 6B is a cross-sectional view seen from the front, and FIG. 7 is an exploded perspective view.

Referring to the drawings, the ball 300 according to the third exemplary embodiment includes a ball main body 310 and insert members 320 attached to both side surfaces of the ball main body 310. The ball main body 310 includes a penetrating hole 311 penetrating from the front portion to the rear portion thereof and having a predetermined diameter, and a concave recess 313 formed on an upper portion thereof to be coupled to a stem (for example, 30 of FIG. 1) of a ball valve.

Each of the left side surface and the right side surface of the ball main body 310 includes a flat surface 315, and includes a protrusion 317 protruding from the surface 315 outwardly, that is, in a direction of being further away from the center of the ball main body 310. The protrusion 317 may be integrally formed with the ball main body 310. In an exemplary embodiment, the ball main body 310 may further include a rim 316 protruding along an outer edge of the flat surface 315 to a predetermined height.

In the third exemplary embodiment, the two insert members 320 are attached to the left and right sides of the ball main body 310, respectively, thereby forming the ball 300. The insert member 320 is a ring-shaped member surrounding the protrusion 317. Accordingly, the ring-shaped insert member 320 fits over the protrusion 317, such that the insert member 320 is coupled to each of the left side and right side of the ball main body 310. The insert member 320 may be coupled to the ball main body 310 by using at least one of laser welding and an adhesive.

In this case, preferably, a surface of the insert member 320 may be configured to cover a region contacting a seat (for example, 14 of FIG. 1) of a ball valve. That is, it is preferable that, when the ball 300 is installed in the ball valve and is placed in a position for closing the ball valve as shown in FIG. 1, a surface of the ring-shaped insert member 320 has a region (“A” region in FIG. 6A) contacting the seat 14 of the ball valve.

An outer surface of the ring-shaped insert member 320 may be formed of a curved surface. For example, the outer surface of the insert member 320 may have the same or similar radius of curvature as or to the radius of curvature of the ball main body 310.

In the illustrated embodiment, the surface of the protrusion 317 of the ball main body 310 has the same radius of curvature as the radius of curvature of the ball main body 310. However, in an alternative embodiment, the surface of the protrusion 317 may be cut to have a flat surface similar to the cut surface 225 of the second embodiment. In this case, as mentioned in the second embodiment, it will be understood that the phenomenon that slurry in a fluid is deposited in a ball valve main body can be reduced.

In addition, as mentioned in the first exemplary embodiment, the ball main body 310 may be fabricated by a metal alloy and then a high hardness coating treatment may be applied to the ball main body 310. The insert member 320 may be formed of a super hardness material having wear resistance. Specific materials of the ball main body 310 and the insert member 320 may be the same as or similar to those of the first exemplary embodiment, and thus a detailed description is omitted.

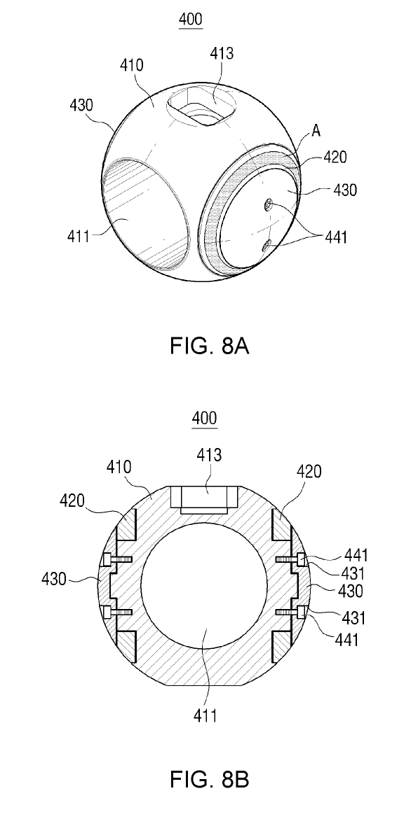

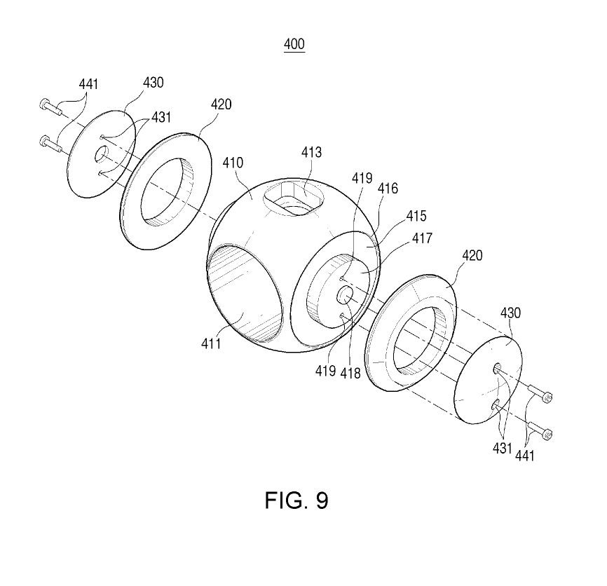

FIGS. 8A and 8B and 9 are views to illustrate a ball 300 according to a fourth exemplary embodiment. FIG. 8A is a perspective view of the ball 400, FIG. 8B is a cross-sectional view seen from the front, and FIG. 9 is an exploded perspective view.

Referring to the drawings, the ball 400 according to the fourth exemplary embodiment includes a ball main body 410, insert members 420 attached to both side surfaces of the ball main body 410, and a fastening cover 430. The ball main body 410 includes a penetrating hole 411 penetrating from the front portion to the rear portion thereof and having a predetermined diameter, and a concave recess 413 formed on an upper portion thereof to be coupled to a stem (for example, 30 of FIG. 1) of a ball valve.

Each of the left side surface and the right side surface of the ball main body 410 includes a flat surface 415, and includes a first protrusion 417 protruding from the surface 415 outwardly, that is, in a direction of being further away from the center of the ball main body 410. The first protrusion 417 may be integrally formed with the ball main body 410. The first protrusion 417 may have a flat surface, and a second protrusion 418 may be additionally formed on a portion of the surface of the first protrusion 417 to face outward and to be coupled to the fastening cover 430. In an exemplary embodiment, the ball main body 410 may further include a rim 416 protruding along an outer edge of the flat surface 415 to a predetermined height.

The two insert members 420 are attached to the left and right sides of the ball main body 410, respectively. The insert member 420 is a ring-shaped member surrounding the protrusion 417. Accordingly, the ring-shaped insert member 420 fits over the protrusion 417, such that the insert member 420 is coupled to each of the left side and right side of the ball main body 410. The insert member 420 may be coupled to the ball main body 410 by using at least one of laser welding and an adhesive.

In this case, preferably, a surface of the insert member 420 may be configured to cover a region contacting a seat (for example, 14 of FIG. 1) of a ball valve. That is, it is preferable that, when the ball 400 is installed in the ball valve and is placed in a position for closing the ball valve as shown in FIG. 1, a surface of the ring-shaped insert member 420 has a region (“A” region in FIG. 8A) contacting the seat 14 of the ball valve.

At least a portion of an outer surface of the ring-shaped insert member 420 may be formed of a curved surface. For example, the outer surface of the insert member 420 may have the same or similar radius of curvature as or to the radius of curvature of the ball main body 410.

The fastening cover 430 may be coupled to the ball main body 410 by covering the protrusion 417 of the ball main body 410 and an outer surface of at least a portion of the ring-shaped insert member 420 surrounding the protrusion 417. The fastening cover 430 may include a recess 432 formed on an inner surface thereof to correspond to the second protrusion 418 of the ball main body 410.

In an exemplary embodiment, the outer surface of the fastening cover 430 may have the same or similar radius of curvature as or to the radius of curvature of the ball main body 420. Accordingly, when the both the insert member 420 and the fastening cover 430 are coupled to the ball main body 410, the left side surface and the right side surface of the ball 400 may have a curved shape having a predetermined radius of curvature.

In an exemplary embodiment, the fastening cover 430 may be coupled to the protrusion 417 by using at least one of laser welding, an adhesive, and screwing. In the illustrated embodiment, the fastening cover 430 may be fastened by screwing. That is, the fastening cover 430 may have one or more screw holes 431 formed thereon, and the first protrusion 417 may have one or more screw holes 419 formed thereon. Accordingly, one or more screws 441 are inserted into the screw holes 419 of the first protrusion 417 through the screw holes 431 and fastened, such that the fastening cover 430 is coupled to the ball main body 410.

The ball main body 410 may be fabricated by a metal alloy and then a high hardness coating treatment may be applied to the ball main body 410. The insert member 420 may be formed of a super hardness material having wear resistance. The fastening cover 430 may be formed of the same or similar material as or to that of the ball main body 410. Specific materials of the ball main body 410 and the insert member 420 may be the same as or similar to those of the first exemplary embodiment, and thus a detailed description is omitted.

While the invention has been shown and described with reference to certain preferred embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

1. A ball installed in a ball valve, the ball comprising:
a ball main body comprising a penetrating hole penetrating from a front portion to a rear portion thereof and having a predetermined diameter, and a concave recess formed on an upper portion thereof to be coupled to a stem of the ball valve; and
insert members formed of a super hardness material and coupled to a left side and a right side of the ball main body,
wherein the insert members are coupled to the ball main body, such that, when the ball is installed in the ball valve and is placed in a position for closing the ball valve, each of the insert members covers a region of the ball contacting a seat of the ball valve,
wherein the insert members are formed of sintered tungsten carbide having a Rockwell hardness (HRa) ranging from 81 to 93, and
wherein the each insert members is coupled to the ball main body by using at least one of welding or adhesive.

2. The ball of claim 1, wherein the ball main body comprises a metal alloy to which high hardness coating is applied.

3. The ball of claim 2, wherein the metal alloy of the ball main body comprises one or more kinds of materials selected from the group consisting of nickel alloy, cobalt alloy, stainless steel, and carbon steel.

4. (canceled)

5. The ball of claim 1, wherein a left side surface and a right side surface of the ball main body each comprises a flat surface, and comprises a protrusion protruding outward from each of the flat surfaces of the left side surface and the right side surface,
wherein each insert member comprises a recess to be engaged with each protrusion, and
wherein each protrusion is inserted into the recess, such that each insert member is coupled to each of the left side surface and the right side surface of the ball main body.

6. (canceled)

7. The ball of claim 5, wherein at least a portion of an outer surface of the left-side insert member has a cut flat surface facing toward the left outer direction of the ball, and at least a portion of an outer surface of the right-side insert member has a cut flat surface facing toward the right outer direction of the ball.

8. (canceled)

9. A ball installed in a ball valve, the ball comprising:
a ball main body comprising a penetrating hole penetrating from a front portion to a rear portion thereof and having a predetermined diameter, and a concave recess formed on an upper portion thereof to be coupled to a stem of the ball valve; and
insert members formed of a super hardness material and coupled to a left side and a right side of the ball main body,
wherein the insert members are coupled to the ball main body, such that, when the ball is installed in the ball valve and is placed in a position for closing the ball valve, each of the insert members covers a region of the ball contacting a seat of the ball valve,
wherein a left side surface and a right side surface of the ball main body each comprises a flat surface, and comprises a protrusion protruding outward from each of the flat surfaces of the left side surface and the right side surface,
wherein each of the insert members is a ring-shaped member surrounding each of the protrusions and is formed of sintered tungsten carbide having a Rockwell hardness (HRa) ranging from 81 to 92, and
wherein the ring-shaped insert member fits over each protrusion and is coupled to the ball main body by using at least one of welding and adhesive, such that the insert member is coupled to each of the left side surface and the right side surface of the ball main body.

10. The ball of claim 9, wherein a left outer surface of the left-side protrusion has a cut flat surface facing toward the left outer direction of the ball, and a right outer surface of the right-side protrusion has a cut flat surface facing toward the right outer direction of the ball.

11. (canceled)

12. The ball of claim 9, further comprising a fastening cover for covering each protrusion of the ball main body and a least a portion of each ring-shaped insert member surrounding each protrusion.

13. The ball of claim 12, wherein a left outer surface of the left-side fastening cover has a cut flat surface facing toward the left outer direction of the ball, and a right outer surface of the right-side fastening cover has a cut flat surface facing toward the right outer direction of the ball.

14. (canceled)

15. A ball valve comprising the ball of claim 1.

16. A ball valve comprising the ball of claim 9.
